(19) United States
(12) Patent Application Publication
(10) Pub. No.: US 2004/0162122 A1
(43) Pub. Date: Aug. 19, 2004

(54) Antenna structure for reducing effects on the human body of electromagnetic waves from mobile communication terminal

(75) Inventor: Chang Muk Lee, Gyeonggi-Do (KR)

Correspondence Address: JONATHAN Y. KANG, ESQ., LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/750,926

(22) Filed: Dec. 30, 2003

(30) Foreign Application Priority Data
Dec. 30, 2002 (KR) 2002-87603

(51) Int. Cl. H04M 1/00

(52) U.S. Cl. 455/575.7; 455/575.1

(57) ABSTRACT

A mobile communication terminal having an electromagnetic wave reducing antenna structure is disclosed. The electromagnetic wave reducing antenna structure includes a radiation type antenna and a reflection type antenna that reflects electromagnetic waves emitted from the radiation type antenna, thereby substantially reducing the amount of electromagnetic waves which are absorbed by the body of a user.

### CROSS-REFERENCE TO RELATED APPLICATIONS

Pursuant to 35 U.S.C. § 119(a), this application claims the benefit of earlier filing date and right of priority to the Korean Application No. 87603/2002, filed on Dec. 30, 2002, the content of which is hereby incorporated by reference herein in its entirety.

### BACKGROUND OF THE INVENTION

1. Field of the Invention

The present invention relates to a mobile communication terminal and, more particularly, to an antenna structure for reducing the effects on the human body of electromagnetic waves emitted from the terminal.

2. Description of the Related Art

As the use of mobile communication terminals has increased, there has been concern about the possible detrimental effects of electromagnetic waves from the terminals on the human body. Some ill effects of the electromagnetic waves emitted by these terminals have actually been recognized. Therefore, efforts are being made to reduce the impact of the electromagnetic waves from mobile communication terminals on the human body, specifically the head of the user.

A conventional folder-type communication terminal 100 is illustrated in FIGS. 1 and 2. The terminal 100 includes a main body portion 110, a foldable portion 120 and a hinge 130 attaching the main body portion 110 to the foldable portion 120.

The main body portion 110 includes a printed circuit board (PCB) (not shown), an antenna 116 coupled between a lower case 112 and an upper case 111, a microphone 114, a keypad 113 positioned at an upper side of the PCB, and a battery pack 115 detachably attached at a rear surface of the lower case 112.

The PCB transmits and receives electrical signals through the antenna 116. The keypad 113 allows the user to input information such as characters and numerals. The battery pack 115 supplies power to operate the terminal 100.

The foldable portion 120 has an LCD 121 and a speaker 122. The LCD 121 displays the operation state of the terminal 100 upon receiving an electrical signal generated from the PCB.

The antenna 116 is protrusively coupled to one side of the main body portion 110. The antenna 116 either receives or transmits electromagnetic waves required for wireless communication.

When a user causes the terminal 100 to enter a call standby state by manipulating the keypad 113 and inputs voice information through the microphone 114, the voice information is converted into an electrical signal and transmitted through the antenna 116. At the same time, electrical signals received through the antenna 116 are converted into voice information and output through the speaker 122.

The antenna 116 transmits/receives the electrical signals as electromagnetic waves for wireless communication. The electromagnetic waves may have a detrimental effect on the human body of the user, specifically the head. The influence of the electromagnetic waves on the human body can be determined by measuring a specific absorption rate (SAR).

In an effort to reduce the effect of the electromagnetic waves from the terminal 100 on the human body of the user, the angle of the antenna 116 may be adjusted. Furthermore, an electromagnetic wave absorption material may be coated on the exterior of the terminal 100.

Adjusting the antenna angle merely increases the distance between the head and the antenna 116 and achieves only a small reduction in the amount of electromagnetic waves from the antenna 116 that are absorbed by the human body. Although coating the exterior of the terminal 100 with an electromagnetic wave absorption material helps reduce the amount of electromagnetic waves from the antenna 116 that are absorbed by the human body, the reduction is insufficient to protect against any detrimental effects.

Therefore, there is a need for a mobile communication terminal that substantially reduces the amount of electromagnetic waves from the terminal that are absorbed by the human body. The present invention addresses this and other needs.

### SUMMARY OF THE INVENTION

The present invention is directed to an antenna structure that substantially reduces the effects on the human body of electromagnetic waves from a mobile communication terminal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied an antenna structure that substantially reduces the effects of electromagnetic waves from a mobile communication terminal on the human body. Specifically, a second antenna is provided on the communication terminal that deflects the electromagnetic waves away from the human body of the user.

In one aspect of the invention, a communication terminal is provided, the terminal including a first antenna and a second antenna adapted to be in close proximity to each other when the terminal is in use. The first antenna is adapted to transmit and receive electromagnetic waves for wireless communication. The second antenna has an inductive reactance and reflects electromagnetic waves emitted from the first antenna.

It is contemplated that the communication terminal may be a folder-type terminal and the second antenna may be located on the outer surface of the foldable portion such that it is in close proximity to the first antenna when the terminal is in the open configuration. Preferably, the first antenna is a radiation-type antenna adapted to be withdrawn from the terminal for use and the second antenna is a reflection-type antenna with a length of at least λ/2 (where λ refers to wavelength). It is further contemplated that the second antenna may be a patch-type micro strip antenna.

In another aspect of the invention, an antenna structure is provided that substantially reduces the amount of electromagnetic waves from a mobile communication terminal that are absorbed by the human body of the user. Two antennas are provided. The first antenna is adapted to transmit and receive electrical signals for wireless communication. The second antenna is adapted to reflect electromagnetic waves emitted from the first antenna away from the human body of the user when the terminal is in use.

Preferably, the first antenna is a radiation-type antenna and the second antenna is a reflection-type antenna that has a length of at least λ/2, an inductive reactance and is adapted to be in close proximity to the first antenna when the terminal is in use. It is contemplated that the second antenna may be a patch-type microstrip antenna.

Other features and advantages of the present invention will become apparent from the following detailed description taken in conjunction with the accompanying drawings, which illustrate, by way of example, the principles of the invention.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a front perspective view of a conventional folder-type communication terminal.

FIG. 2 is a rear view of the communication terminal illustrated in FIG. 1.

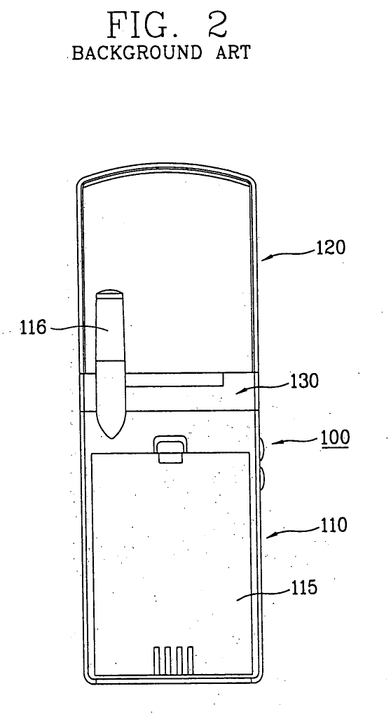

FIG. 3 is a rear perspective view of one embodiment of a communication terminal in accordance with the present invention.

FIG. 4 is a rear view of the communication terminal illustrated in FIG. 3.

FIG. 5 is a schematic illustration of the operation of the antenna structure of the present invention.

FIG. 6 is a graph showing the relationship between the length and the reactance of the second antenna of the present invention.

### DETAILED DESCRIPTION OF THE PREFERRED EMBODIMENTS

The present invention relates to an antenna structure that substantially reduces the effects of electromagnetic waves from a mobile communication terminal on the human body. Although the present invention is illustrated with regard to a folder-type mobile communication terminal, it is contemplated that the present invention may be utilized with any type or configuration of communication terminal (for example, PDA or notebook with wireless communication capabilities) or anytime it is desired to substantially reduce the effects of electromagnetic waves from a communication terminal on the human body.

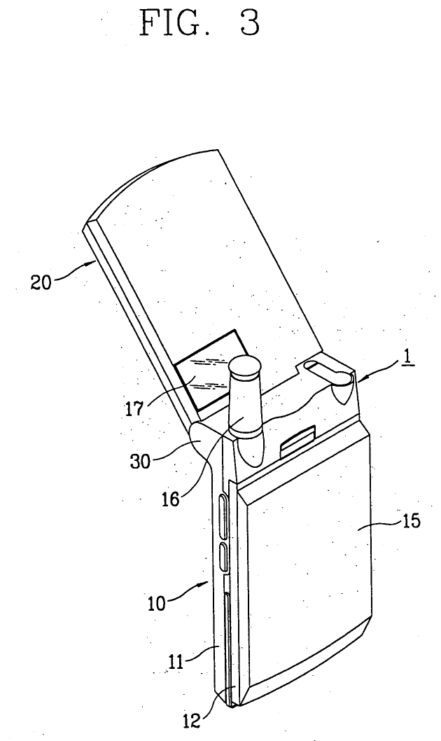

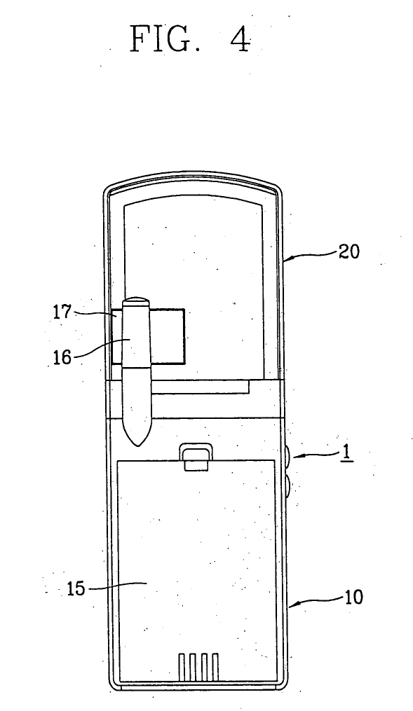

Referring to FIGS. 3 and 4, one embodiment of the present invention is illustrated. The folder-type mobile communication terminal 1 includes a main body portion 10, a foldable portion 20 attached to one side of the main body portion 10 by a hinge 30, a first antenna 16, and a second antenna 17 attached at a rear side of the foldable portion 20. When the terminal 1 is in the open configuration, the second antenna 17 is in close proximity to the first antenna 16 and reflects electromagnetic waves emitted from the first antenna 16. It is contemplated that the first antenna 16 may be adapted to be withdrawn from one upper side of the main body portion 10 when the terminal is in use.

The first antenna 16 is a general radiation-type antenna and the second antenna 17, preferably, is a reflection-type antenna, and more preferably a patch-type microstrip antenna. Preferably, the second antenna 17 is formed with at least a ½ wavelength such that it has an inductive reactance.

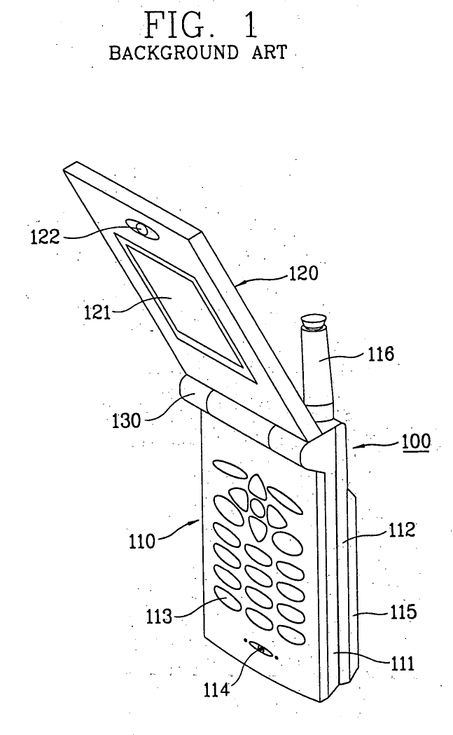

The main body portion 10 includes a printed circuit board (PCB) contained therein (not shown), a microphone 114 and keypad 113 similar to those illustrated in FIG. 1, and a battery pack 15 detachably attached at a rear surface. The microphone 114 allows the user to input voice information. The keypad 113 allows the user to input information such as characters and numbers. The detachable battery pack 15 provides power for operation of the terminal 1.

The foldable portion 20 includes an LCD 121 and a speaker 122 similar to those illustrated in FIG. 1. The LCD 121 processes an electrical signal generated from the PCB of the main body portion 10 and displays the operation state of the terminal 1. The speaker 122 reproduces voice information received by the terminal 1 through the first antenna 16.

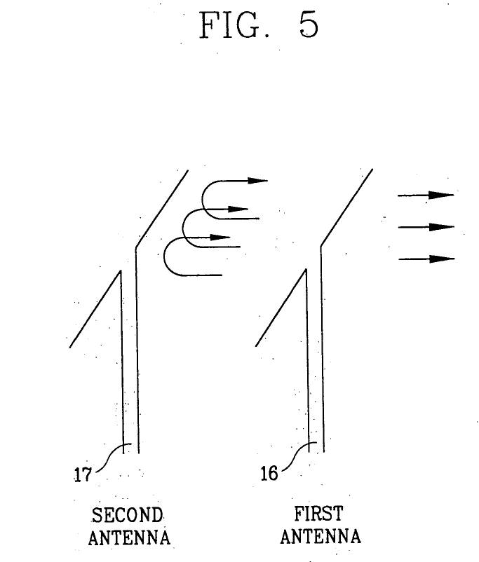

Referring to FIG. 5, the operation of an antenna structure in accordance with the present invention is illustrated. The present invention utilizes the principle of a Yagi antenna consisting of a reflector and a radiator. The first antenna 16 serves as a radiator, while the second antenna 17 serves as a reflector. The second antenna 17 reflects the electromagnetic waves emitted from the first antenna 16 away from the human body of the user, specifically away from the head.

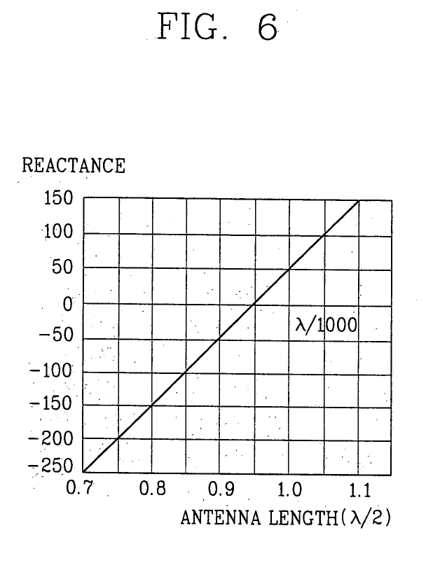

FIG. 6 illustrates the relationship between the length of an element, such as the second antenna 17, and the reactance component of that element. If the element is longer than λ/2*0.96 (where λ represents wavelength), the element becomes inductive. If the element is shorter, it becomes capacitive. For reference, an inductive element is operated in the same manner as a high frequency applied to a coil and a capacitive element is operated in the same manner as a high frequency applied to a capacitor.

With further reference to FIG. 6, if second antenna 17 has the length λ/2 or greater, the second antenna 17 becomes an inductive antenna. When a high frequency is applied to the second antenna 17, the high frequency current flows slower by 90° compared to the voltage.

If, however, the second antenna 17 is shorter than λ/2*0.96, the second antenna 17 becomes a capacitive antenna. When a high frequency is applied to the second antenna 17, the high frequency current flows faster by 90° compared to the voltage.

The second antenna 17 of the present invention has a length of λ/2 or greater such that the second antenna 17 has an inductive reactance. In operation, when the user manipulates the keypad 113 of the terminal 1 to enter a call standby state and inputs voice information through the microphone 114, a voice signal is converted into an electrical signal and transmitted through the first antenna 16.

The electromagnetic waves emitted from the first antenna 16 reach the second antenna 17 with a 90°-delayed phase difference due to the inductive reactance of the second antenna, wherein the phase of the current is slower than the voltage by 90°. Electromagnetic waves are reflected by the second antenna 17 but, because the phase of the current is slower than the voltage by 90°, the reflected electromagnetic waves reach the first antenna 16 with the 90°-delayed phase difference.

Therefore, the degree of absorption of the electromagnetic waves by the human body, or the specific absorption rate (SAR), can be substantially reduced. Furthermore, a greater receiving gain (the radiated electromagnetic waves added to the reflected electromagnetic waves) can be obtained due to the electromagnetic waves radiated from the first antenna 16 and the electromagnetic waves reflected from the second antenna 17.

The antenna structure of the present invention has several advantages. The electromagnetic waves radiated from the radiation type antenna 16 can be directed away from the head of the user, and therefore, any damage to the human body of the user can be substantially reduced. Furthermore, greater receiving gain can be obtained.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A mobile communication terminal comprising:
a first antenna; and
a second antenna attached to the terminal in proximity to the first antenna such that the second antenna at least partially reflects electromagnetic waves emitted from the first antenna.

2. The terminal of claim 1, wherein the second antenna has an inductive reactance.

3. The terminal of claim 1, wherein the first antenna is a radiation-type antenna and the second antenna is a reflection type antenna.

4. The terminal of claim 1, wherein the second antenna is a patch-type microstrip antenna.

5. The terminal of claim 1, wherein the second antenna has a length of at least λ/2.

6. The terminal of claim 1, further comprising a foldable portion attached to a main body portion such that the terminal has an open configuration and a closed configuration.

7. The terminal of claim 6, wherein the first antenna is attached at an upper surface of the main body portion and the second antenna is attached at a rear surface of the foldable portion such that the second antenna is in close proximity to the first antenna when the terminal is in the open configuration.

8. An antenna structure for reducing the absorption of electromagnetic waves by the body of the user of a mobile communication terminal, comprising:
a first antenna; and
a second antenna that at least partially reflects electromagnetic waves emitted from the first antenna when the terminal is in use.

9. The antenna structure of claim 8, wherein the first antenna is a radiation-type antenna and the second antenna is a reflection-type antenna.

10. The antenna structure of claim 8, wherein the second antenna has an inductive reactance.

11. The antenna structure of claim 8, wherein the second antenna is adapted to be in close proximity to the first antenna when the terminal is in use.

12. The antenna structure of claim 8, wherein the first antenna is adapted to be withdrawn from the terminal.

13. The antenna structure of claim 8, wherein the second antenna is a patch-type microstrip antenna.

14. The antenna structure of claim 8, wherein the second antenna has a length of at least λ/2.

15. The antenna structure of claim 8, wherein the second antenna reflects the electromagnetic waves in the opposite direction of the head of the user.

16. A mobile communication terminal comprising:
a main body portion attached to a foldable portion such that the terminal has a closed configuration and an open configuration;
a first antenna adapted to be withdrawn from the main body portion; and
a second antenna attached to the foldable portion such that the second antenna is in close proximity to the first antenna when the terminal is in the open configuration;
wherein the second antenna reflects electromagnetic waves emitted from the first antenna when the terminal is in use.

17. The terminal of claim 16, wherein the second antenna has an inductive reactance.

18. The terminal of claim 16, wherein the first antenna is a radiation-type antenna and the second antenna is a reflection type antenna.

19. The terminal of claim 16, wherein the second antenna is a patch-type microstrip antenna.

20. The terminal of claim 16, wherein the second antenna has a length of at least λ/2.
